(19) United States
(12) Patent Application Publication
(10) Pub. No.: US 2026/0080667 A1
(43) Pub. Date: Mar. 19, 2026

(54) APPARATUS AND METHOD FOR TRAINING ARTIFICIAL INTELLIGENCE MODEL

(71) Applicant: AGENCY FOR DEFENSE DEVELOPMENT, Daejeon (KR)

(72) Inventors: Jeong Seok KIM, Daejeon (KR); Hyun Seong KANG, Daejeon (KR); Jeong Hyun BAEK, Daejeon (KR); Hyun Ja IM, Daejeon (KR)

(21) Appl. No.: 19/325,835

(22) Filed: Sep. 11, 2025

(30) Foreign Application Priority Data
Sep. 13, 2024 (KR) 10-2024-0125755

(51) Int. Cl. G06V 10/774; G06T 3/40; G06T 3/60; G06T 11/60

(52) U.S. Cl. CPC G06V 10/774; G06T 3/40; G06T 3/60; G06T 11/60

(57) ABSTRACT

Disclosed are an apparatus and a method for training an artificial intelligence model. According to the present disclosure, the apparatus for training an artificial intelligence model may generate a dataset that corresponds to input prompts and is classified by a plurality of categories, delete partial data from the dataset based on based on inference results obtained by inputting data included in the dataset into a plurality of pre-trained first artificial intelligence models, augment, by applying a preset algorithm, the dataset from which the partial data is deleted, train a second artificial intelligence model based on the augmented dataset, calculate inference performance of the second artificial intelligence model for each of the plurality of categories based on an inference result obtained by inputting a test dataset into the trained second artificial intelligence model, and adjust generation of the input prompts for the plurality of categories based on the inference performance.

### PRIORITY INFORMATION

This application claims the benefit of Korean Patent Application No. 10-2024-0125755, filed on Sep. 13, 2024, in the Korean Intellectual Property Office, the disclosure of which is incorporated herein by reference in its entirety.

### FIELD OF THE INVENTION

The present disclosure relates to a self-paced learning (SPL) artificial intelligence technique that generates data by using an artificial intelligence model when it is difficult to obtain massive data and label information, and utilizes the data as learning data.

### DESCRIPTION OF THE RELATED ART

The quality and quantity of data have a significant influence on model training and performance in the fields of artificial intelligence and computer vision. In particular, for training an artificial intelligence model, it is important to secure a sufficient quantity of data that reflects various scenarios and conditions required for training.

For example, supervised learning of an artificial intelligence model requires massive high-quality data. Such data is essential to train the artificial intelligence model for various situations and patterns in the real world and enable the artificial intelligence model to perform accurate predictions. However, in the real world, it is often difficult to secure massive data corresponding to a specific field or a specific condition. Such a lack of data may restrict the performance and generalization capability of the artificial intelligence model and also restrict its applicability to real-world environments. More specifically, it may be difficult to collect data that is sensitive to specific weather conditions, the military, medical care, or personal information. In this case, the artificial intelligence model may be trained only for limited scenarios, causing a biased result.

In a supervised learning process, the artificial intelligence model may learn a relationship between input data and an accurate label (classification label, prediction value) with respect to the input data. “Label” refers to a ground truth or a target output value assigned to each data and indicates a value to be predicted while the artificial intelligence model learns. Since such a label is assigned to data by human labor, it is challenging to generate a dataset including data and labels in the real world.

### SUMMARY OF THE INVENTION

Accordingly, the present disclosure substantially obviates one or more problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

According to a disclosed example embodiment, a method for training an artificial intelligence model includes generating, by using a generative artificial intelligence model, a dataset that corresponds to input prompts and is categorized by a plurality of categories, delete partial data from the dataset based on inference results obtained by inputting data included in the dataset into a plurality of pre-trained first artificial intelligence models, augmenting, by applying a preset algorithm, the dataset from which the partial data is deleted, training a second artificial model based on the augmented dataset, calculating inference performance of the second artificial intelligence model for each of the plurality of categories based on an inference result obtained by inputting a test dataset into the trained second artificial intelligence model, and adjusting generation of the input prompts for the plurality of categories based on the inference performance.

According to an example embodiment, the generating of the dataset may include inputting the input prompts classified for each of the plurality of categories into the generative artificial intelligence model. In addition, the plurality of categories of the input prompts may include information matching a keyword that is input into a prompt generation artificial intelligence model for the generation of the input prompts.

Meanwhile, according to an example embodiment, the dataset may include data that is output by the generative artificial intelligence model for the input prompts and ground truths (GTs) matching the input prompts.

Meanwhile, according to an example embodiment, the deleting of the partial data from the dataset may include inputting data of the dataset into each of the plurality of first artificial intelligence models, determining whether inference results that are output by the plurality of first artificial intelligence models correspond to the GTs matching the data, preserving the data when a ratio of the inference results corresponding to the GTs to total inference results is equal to or greater than a preset threshold, and deleting the data when the ratio of the inference results corresponding to the GTs to the total inference results is less than the preset threshold.

Meanwhile, according to an example embodiment, the augmenting of the dataset from which the partial data is deleted may include performing at least one task among stylization, image rotation, resizing, and color adjustment at least a portion of data within the dataset from which the partial data is deleted.

Meanwhile, according to an example embodiment, the calculating of the inference performance may include inputting data of the test dataset into the second artificial intelligence model, determining whether an inference result that is output by the second artificial intelligence model corresponds to a GT matching the data, and calculating, as the inference performance, accuracy of the second artificial intelligence model for each of the plurality of categories according to a result of the determining.

Meanwhile, according to an example embodiment, the adjusting of the generation of the input prompts for the plurality of categories may include controlling the prompt generation artificial intelligence model so that a generation ratio of the input prompts for each of the plurality of categories is determined according to the inference performance for each of the plurality of categories.

According to a disclosed example embodiment, an apparatus for training an artificial intelligence model includes a transceiver, a memory that stores instructions, and a processor. The processor is connected to the transceiver and the memory to generate a dataset that corresponds to input prompts and is categorized by a plurality of categories, delete partial data from the dataset based on inference results obtained by inputting data included in the dataset into a plurality of pre-trained first artificial intelligence models, augment, by applying a preset algorithm, the dataset from which the partial data is deleted, train a second artificial intelligence model based on the augmented dataset, calculate inference performance of the second artificial intelligence model for each of the plurality of categories based on an inference result obtained by inputting a test dataset into the trained second artificial intelligence model, and adjust generation of the input prompts for the plurality of categories based on the inference performance.

According to a disclosed example embodiment, a non-transitory computer readable storage medium including a medium configured to store computer readable instructions. When executed by a processor, the computer readable instructions allow the processor to perform a method for training an artificial intelligence model, the method including generating, by using a generative artificial intelligence model, a dataset that corresponds to input prompts and is categorized by a plurality of categories, deleting partial data from the dataset based on inference results obtained by inputting data included in the dataset into a plurality of pre-trained first artificial intelligence models, augmenting, by applying a preset algorithm, the dataset from which the partial data is deleted, training a second artificial intelligence model based on the augmented dataset, calculating inference performance of the second artificial intelligence model for each of the plurality of categories based on an inference result obtained by inputting a test dataset into the trained second artificial intelligence model, and adjusting generation of the input prompts for the plurality of categories based on the inference performance.

It is to be understood that both the foregoing general description and the following detailed description are exemplary and explanatory and are intended to provide further explanation of the invention as claimed.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a schematic configuration of a system for training an artificial intelligence model according to an example embodiment of the present disclosure;

FIG. 2 is a flowchart for describing a method of training an artificial intelligence model according to an example embodiment;

FIG. 3 is a block diagram for structurally describing an apparatus for training an artificial intelligence model according to an example embodiment;

FIG. 4 is a block diagram for functionally describing an apparatus for training an artificial intelligence model according to an example embodiment;

FIG. 5 is a diagram conceptually illustrating a process of training an artificial intelligence model according to an example embodiment;

FIG. 6 is a diagram illustrating a process of evaluating image quality in detail according to an example embodiment; and

FIG. 7 is a diagram illustrating a feedback process of a generative artificial intelligence model and an operation process of a prompt generation artificial intelligence model in detail according to an example embodiment.

### DETAILED DESCRIPTION

Terms used in the example embodiments are selected, as much as possible, from general terms that are widely used at present while taking into consideration the functions obtained in accordance with the present disclosure, but these terms may be replaced by other terms based on intentions of those skilled in the art, customs, emergence of new technologies, or the like. Also, in a particular case, terms that are arbitrarily selected by the applicant of the present disclosure may be used. In this case, the meanings of these terms may be described in corresponding description parts of the disclosure. Accordingly, it should be noted that the terms used herein should be construed based on practical meanings thereof and the whole content of this specification, rather than being simply construed based on names of the terms.

In the entire specification, when a component is referred to as “including” another component, the component should not be understood as excluding other components so long as there is no special conflicting description, and the component may include at least one other component. In addition, the terms “unit” and “module”, for example, may refer to a component that exerts at least one function or operation, and may be realized in hardware or software, or may be realized by a combination of hardware and software. Unlike the illustrated examples, specific operations may not be clearly distinguished.

The expression “at least one of A, B, and C” may indicate the following meaning including: A alone; B alone; C alone; both A and B together; both A and C together; both B and C together; or all three of A, B, and C together.

In the present disclosure, an “electronic apparatus” may be implemented as a computer or a portable terminal capable of accessing a server or another terminal through a network. Here, the computer may include, for example, a laptop computer, a desktop computer, and a notebook equipped with a web browser. The portable terminal may be a wireless communication device ensuring a portability and a mobility, and include any type of handheld wireless communication device, for example, a tablet PC, a smartphone, a communication-based terminal such as international mobile telecommunication (IMT), code division multiple access (CDMA), W-code division multiple access (W-CDMA), and long term evolution (LTE).

In the following description, terms such as “transmission,” “communication,” “sending,” “reception,” and other similar expressions of signals or information are not limited to the direct transfer of signals or information from one component to another, but also include cases where the transfer is made via one or more other components.

In particular, when a signal or information is “transmitted” or “sent” to a component, it indicates the final destination of the signal or information, and does not necessarily mean a direct destination. The same applies to the “reception” of a signal or information. In addition, in the present specification, when two or more pieces of data or information are “related,” it means that obtaining one piece of data (or information) allows at least a portion of other data (or information) to be obtained based on it.

In addition, terms such as “first,” “second,” and the like may be used to describe various components, but the components should not be limited by such terms. Such terms may be used merely for the purpose of distinguishing one component from another.

For example, without departing from the scope of the present disclosure, a “first” component may be referred to as a “second” component, and similarly, the “second” component may be referred to as the “first” component.

In describing the example embodiments, descriptions of technical contents that are well known in the art to which the present disclosure belongs and are not directly related to the present specification will be omitted. This is to more clearly communicate without obscure the subject matter of the present specification by omitting unnecessary description.

For the same reason, in the accompanying drawings, some components are exaggerated, omitted or schematically illustrated. In addition, the size of each component does not fully reflect the actual size. The same or corresponding components in each drawing are given the same reference numerals.

Advantages and features of the present disclosure and methods of achieving them will be apparent from the following example embodiments that will be described in more detail with reference to the accompanying drawings. It should be noted, however, that the present disclosure is not limited to the following example embodiments, and may be implemented in various forms. Accordingly, the example embodiments are provided only to disclose the present disclosure and let those skilled in the art know the category of the present disclosure, and the present disclosure is only defined by the category of claims. The same reference numerals or the same reference designators denote the same components throughout the specification.

It will be understood that each block of the flowchart illustrations and combinations of flowchart illustrations may be performed by computer program instructions. Since these computer program instructions may be mounted on a processor of a general purpose computer, special purpose computer, or other programmable data processing equipment, those instructions executed through the computer or the processor of other programmable data processing equipment may create a means to perform the functions be described in flowchart block(s). These computer program instructions may be stored in a computer usable or computer readable memory that can be directed to a computer or other programmable data processing equipment to implement functionality in a particular manner, and thus computer program instructions stored in the computer usable or computer readable memory can produce an article of manufacture containing instruction means for performing the functions described in the flowchart block(s). Computer program instructions may also be mounted on a computer or other programmable data processing equipment, such that a series of operating steps may be performed on the computer or other programmable data processing equipment to create a computer-implemented process to create a computer or other programmable data. Instructions for performing the processing equipment may also provide steps for performing the functions described in the flowchart block(s).

In addition, each block may represent a portion of a module, segment, or code that includes one or more executable instructions for executing a specified logical function(s). It should also be noted that in some alternative implementations, the functions noted in the blocks may occur out of order. For example, the two blocks shown in succession may in fact be executed substantially concurrently, or the blocks may sometimes be executed in the reverse order, depending on the corresponding function.

In the following description, example embodiments of the present disclosure will be described in detail with reference to the drawings so that those skilled in the art can easily carry out the present disclosure. However, the present disclosure may be embodied in many different forms and is not limited to the embodiments described herein.

Hereinafter, example embodiments of the present disclosure will be described in detail with reference to the accompanying drawings.

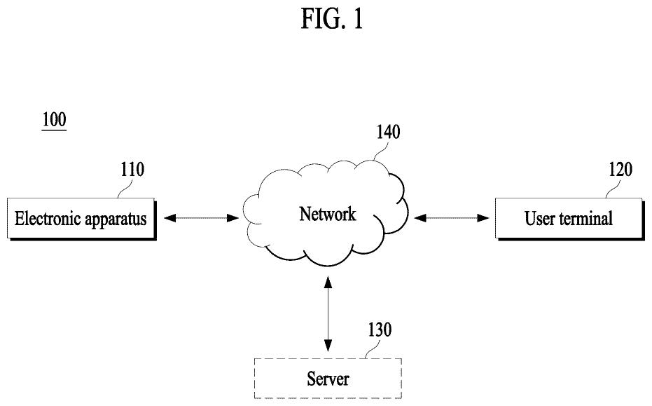

FIG. 1 is a diagram illustrating a schematic configuration of a system for training an artificial intelligence model according to an example embodiment of the present disclosure.

As illustrated, according to an example embodiment, a system 100 for training an artificial intelligence model includes an electronic apparatus 110, a user terminal 120, and a network 140. According to another example embodiment, the system 100 may further include a server 130 additionally. It will be understood by those skilled in the art that, in addition to the components illustrated in FIG. 1, other general-purpose components may also be included.

The electronic apparatus 110 may receive training instructions for an artificial intelligence model through the network 140 in a wired or wireless manner from the user terminal 120. The training instructions transmitted from the user terminal 120 may be instructions simply to train the artificial intelligence model. However, according to an example embodiment, the training instructions may be instructions including information that specifies which category of data (for example, a keyword) is to be used for training. Meanwhile, the electronic apparatus 110 may perform training for the artificial intelligence model by itself every predetermined cycle or whenever a preset condition is satisfied, even without receiving the training instructions from the user terminal 120.

The electronic apparatus 110 may be provided with one or more computation devices (for example, a graphics processing unit (GPU) and a central processing unit (CPU)) and perform a training procedure for the artificial intelligence model. Here, the electronic apparatus 110 may refer to a physically single server. However, when the training of the artificial intelligence model requires a large amount of computation, so that a large-scale computation device needs to be used, the electronic apparatus 110 may refer to a server cluster including servers equipped with a computation device. In this case, servers composing the electronic apparatus 110 may electronically communicate with one another in a wired or wireless manner.

The user terminal 120 may transmit the training instructions for the artificial intelligence model to the electronic apparatus 110 through input of text, buttons, sounds, or gestures from a user. Here, the user terminal 120 may be a client terminal such as a personal computer (PC), a tablet, and a smartphone, or according to an example embodiment, may refer to a server cluster including a specific server or a plurality of servers. According to an example embodiment, the user terminal 120 may include an input part (for example, a microphone, a camera, and a keyboard) that converts a signal input by a user into a format identifiable by the electronic apparatus 110 and an output part (for example, a display) that outputs a signal transmitted by the electronic apparatus 110 into a format identifiable by the user.

Meanwhile, in the present specification, for training an artificial intelligence model, an artificial intelligence model to be trained (referred to as “second artificial intelligence model” hereinafter), a generative artificial intelligence model that generates a dataset to be used for training, a first artificial intelligence model that evaluates data quality and is used to preserve only high-quality data, and a prompt generation artificial intelligence model that generates input prompts for generating the dataset are necessary. In addition, massive datasets are necessary in a process of training the artificial intelligence model. The artificial intelligence models and the datasets may be stored in an internal storage of the electronic apparatus 110 or, according to an example embodiment, in the separate server 130 that communicates with the electronic apparatus 110 through the network 140. For example, when the server 130 is a server that provides a cloud service, the electronic apparatus 110 may utilize the dataset stored in the server 130 to perform training for the artificial intelligence model, thereby providing only a computation function for training without being equipped with a massive storage medium separately.

Meanwhile, the wired or wireless network 140 used to transmit input and output between the electronic apparatus 110 (in an example embodiment, the server 130 may also be included) and the user terminal 120 may include a local area network (LAN), a wide area network (WAN), a value added network (VAN), a mobile radio communication network, a satellite communication network, or a combination thereof. The wired or wireless network 140 is a comprehensive data communication network that allows each network component illustrated in FIG. 1 to communicate smoothly with one another, and may include wired Internet, wireless Internet, and mobile wireless communication networks. For example, wireless communication may include a wireless LAN (Wi-Fi), Bluetooth, Bluetooth Low Energy, Zigbee, Wi-Fi Direct (WFD), an ultra wideband (UWB), infrared data association (IrDA), and near field communication (NFC), but is not limited thereto.

In relation to the above, a more detailed description will be provided with reference to the drawings below.

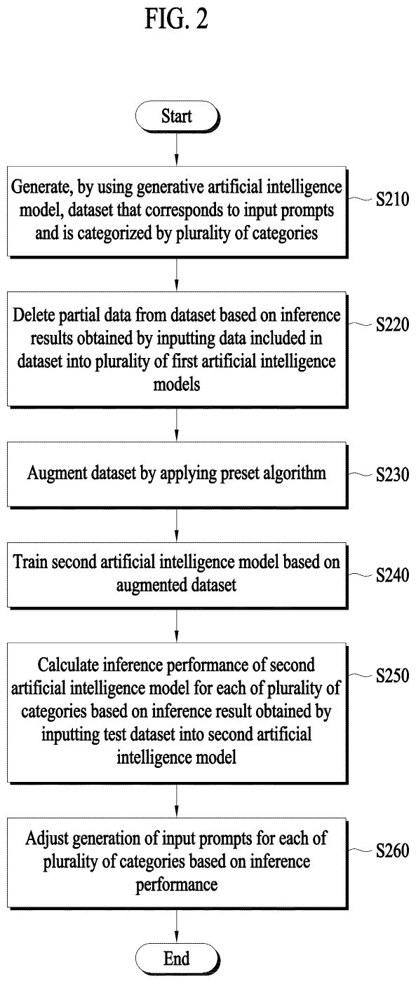

FIG. 2 is a flowchart for describing a method of training an artificial intelligence model according to an example embodiment. For example, the method illustrated in FIG. 2 may be performed by the above-mentioned electronic apparatus 110.

In operation S210, the electronic apparatus 110 may generate, by using a generative artificial intelligence model, a dataset that corresponds to input prompts and is categorized by a plurality of categories. More specifically, the electronic apparatus 110 may generate the dataset that has the plurality of categories corresponding to the input prompts by inputting the input prompts classified for each of the plurality of categories into the generative artificial intelligence model. The plurality of categories of the input prompts may be set variously. As an example, the plurality of categories of the input prompts may include information matching a keyword that is input into a prompt generation artificial intelligence model for generation of the input prompts. Accordingly, the dataset generated by the electronic apparatus 110 may be specified as information matching the keyword that is used to generate the input prompts corresponding to the dataset. For example, a dataset generated by inputting input prompts that are generated by various keywords matching the theme of “winter” into the generative artificial intelligence model may be categorized into the category of “winter.”

According to an example embodiment, the dataset generated by the electronic apparatus 110 may include: (1) data output by the generative artificial intelligence model for the input prompts; and (2) ground truths (GTs) matching the input prompts. More specifically, the GTs matching the input prompts may include a keyword used to generate the input prompts. When the used keyword is a plurality of keywords, the GTs may include a portion of the plurality of keywords or include all of the plurality of keywords. Meanwhile, the GTs matching the input prompts may be information matching the keyword used to generate the input prompts. Meanwhile, the GTs matching the input prompts may include both the keyword and the information matching the keyword together.

In operation S220, the electronic apparatus 110 may delete partial data from the dataset based on inference results obtained by inputting data included in the dataset into a plurality of first artificial intelligence models.

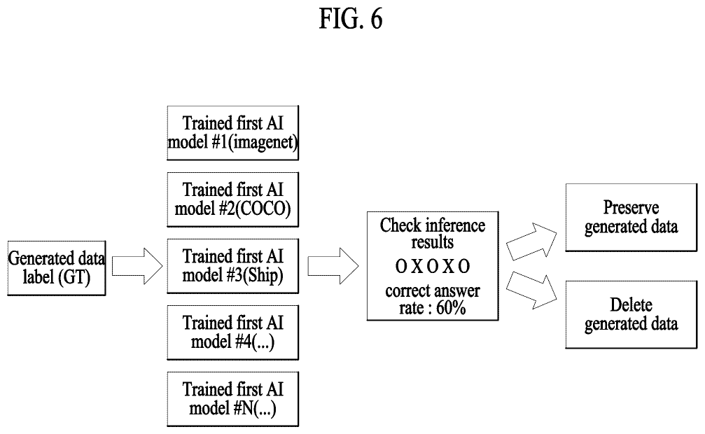

According to an example embodiment, the electronic apparatus 110 may input data of the dataset into the plurality of first artificial intelligence models, determine whether the inference results output by the plurality of first artificial intelligence models correspond to the GTs matching the data, and preserve the data when a ratio of the inference results corresponding to the GTs to total inference results is equal to or greater than a preset threshold. In addition, the electronic apparatus 110 may delete the data when the ratio of the inference results corresponding to the GTs to the total inference results is less than the preset threshold. Further details will be described below with reference to FIG. 6.

In operation S230, the electronic apparatus 110 may augment, by applying a preset algorithm, the dataset from which the partial data is deleted. More specifically, the electronic apparatus 110 may augment the data by performing at least one task among stylization, image rotation, resizing, and color adjustment for at least a portion of data within the dataset from which the partial data is deleted. For example, when data remaining in the dataset is a form of a synthesized video (image), the electronic apparatus 110 may generate a new video by rotating the video, resizing the video, at least partially changing a value of color information (for example, RGB) included in the video, or applying a texture or style option similar to an actual picture to the video. By incorporating the generated new video in the dataset, the electronic apparatus 110 may construct an augmented dataset.

In operation S240, the electronic apparatus 110 may train a second artificial intelligence model based on the augmented dataset.

In operation S250, the electronic apparatus 110 may calculate inference performance of the second artificial intelligence model for each of the plurality of categories based on an inference result obtained by inputting a test dataset into the trained second artificial intelligence model.

According to an example embodiment, the electronic apparatus 110 may input data of the test dataset into the second artificial intelligence model, determine whether an inference result output by the second artificial intelligence model corresponds to a GT matching the data, and calculate accuracy of the second artificial intelligence model for each of the plurality of categories as inference performance of the second artificial intelligence model for each of the plurality of categories according to a result of the determining.

In operation S260, the electronic apparatus 110 may adjust generation of the input prompts for each of the plurality of categories based on the inference performance of the second artificial intelligence model for each of the plurality of categories.

According to an example embodiment, the electronic apparatus 110 may control the prompt generation artificial intelligence model so that a generation ratio of the input prompts for each of the plurality of categories is determined according to the inference performance for each of the plurality of categories. For example, assuming that the accuracy of the second artificial intelligence model for each of the plurality of categories is the inference performance, when accuracies of category A, category B, and category C are 40%, 80%, and 80%, respectively, the electronic apparatus 110 may control the prompt generation artificial intelligence model to generate input prompts for category A, category B, and category C in a ratio of 2:1:1. However, this is merely an example, and the electronic apparatus 110 does not necessarily determine a generation ratio of input prompts for each of the plurality of categories in inverse proportion to inference performance for each of the plurality of categories. In other words, the electronic apparatus 110 may determine a relatively higher generation ratio of input prompts for a category with relatively lower inference performance. However, the electronic apparatus 110 may determine an equal generation ratio of input prompts for categories belonging to an equal inference performance section (for example, accuracy of 70% or greater and less than 80%) or determine not to generate input prompts for a category corresponding to certain inference performance or greater.

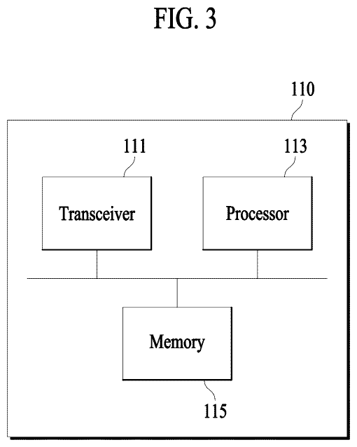

FIG. 3 is a block diagram for structurally describing an apparatus for training an artificial intelligence model according to an example embodiment. For convenience of description, an apparatus for training an artificial intelligence model illustrated in FIG. 3 is referred to as an electronic apparatus 110. According to an example embodiment, the electronic apparatus 110 may include a transceiver 111, a processor 113, and a memory 115. The electronic apparatus 110 may be connected through the transceiver 111 to other external devices and exchange data.

The processor 113 may perform at least one method described through the present specification. The memory 115 may store information for performing at least one method described through the present specification. The memory 115 may be a volatile memory or a non-volatile memory.

The processor 113 may control the electronic apparatus 110 to execute a program and provide information. A code of the program executed by the processor 113 may be stored in the memory 115.

The processor 113 may be connected to the transceiver 111 and the memory 115 to generate, by using a generative artificial intelligence model, a dataset that corresponds to input prompts and is categorized by a plurality of categories, delete partial data from the dataset based on inference results obtained by inputting data included in the dataset into a plurality of pre-trained first artificial intelligence models, augment, by applying a preset algorithm, the dataset from which the partial data is deleted, train a second artificial intelligence model based on the augmented dataset, calculate inference performance of the second artificial intelligence model for each of the plurality of categories based on an inference result obtained by inputting a test dataset into the trained second artificial intelligence model, and adjust generation of the input prompts for the plurality of categories based on the inference performance. In addition, according to an example embodiment, the electronic apparatus 110 may further include an interface that may provide information to a user.

According to the electronic apparatus 110 illustrated in FIG. 3, only components related to the example embodiment are illustrated. Accordingly, it will be understood by those skilled in the art that, in addition to the components illustrated in FIG. 3, other general-purpose components may also be included.

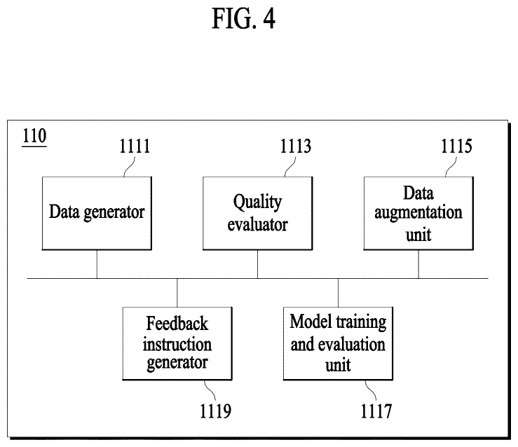

FIG. 4 is a block diagram for functionally describing an apparatus for training an artificial intelligence model according to an example embodiment. For convenience of description, an apparatus for training an artificial intelligence model illustrated in FIG. 4 is referred to as an electronic apparatus 110. According to an example embodiment, as illustrated in FIG. 4, the electronic apparatus 110 may include a data generator 1111, a quality evaluator 1113, a data augmentation unit 1115, a model training and evaluation unit 1117, and a feedback instruction generator 1119. These are modules that are classified according to functions performed in the electronic apparatus 110. Each module may electronically communicate and exchange data in the electronic apparatus 110. In FIG. 4, each module is illustrated as being connected via a bus. However, this is merely an example, and a method of connecting the modules is not limited thereto.

The data generator 1111 may generate, by using a generative artificial intelligence model, a dataset that corresponds to input prompts and is categorized by a plurality of categories. The data generator 1111 may generate high-quality data (for example, image data) that reflects various environmental conditions by using the generative artificial intelligence model and, through this, provide data under various scenarios to an artificial intelligence model, which is a target to be trained.

The quality evaluator 1113 may obtain an inference result by inputting data included in the generated dataset into a plurality of pre-trained first artificial intelligence models, delete partial data from the dataset based on the inference result, and preserve the remaining data. Through this, the quality evaluator 1113 may discard low-quality data and transmit only high-quality data to the data augmentation unit 1115, thereby performing a function of filtering data. This is to promote quantitative expansion of the dataset as well as qualitative enhancement of the dataset.

The data augmentation unit 1115 may augment data of the dataset by applying a preset algorithm to the dataset from which the partial data is deleted. Through this, the data augmentation unit 1115 may convert data in the dataset to be more so as to have an effect similar to using data collected from real environments to train an artificial intelligence model, and may enhance performance of the artificial intelligence model by increasing quantity of data.

The model training and evaluation unit 1117 may obtain an inference result by inputting a test dataset into a second artificial intelligence model and, based on the inference result, calculate inference performance of the second artificial intelligence model for each of the plurality of categories. More specifically, the model training and evaluation unit 1117 may perform deep learning for the second artificial intelligence model for each of the plurality of categories to recognize strengths and weaknesses of the second artificial intelligence model for each of the plurality of categories and identify which category of the second artificial intelligence model needs to be supplemented.

The feedback instruction generator 1119 may adjust generation of the input prompts for each of the plurality of categories based on the inference performance. For example, the feedback instruction generator 1119 may control the prompt generation artificial intelligence model to generate more input prompts for a category with lower inference performance to enable the data generator 1111 to generate more data for the category. Conversely, the feedback instruction generator 1119 may control the prompt generation artificial intelligence model to reduce generation of input prompts for a category with higher inference performance to enable the data generator 1111 to generate less data for the category. Through this, the second artificial intelligence model, as the target to be trained, may be trained to achieve balanced performance across all of the plurality of categories and utilized more universally as the reliability and generalization capability of the second artificial intelligence model are enhanced.

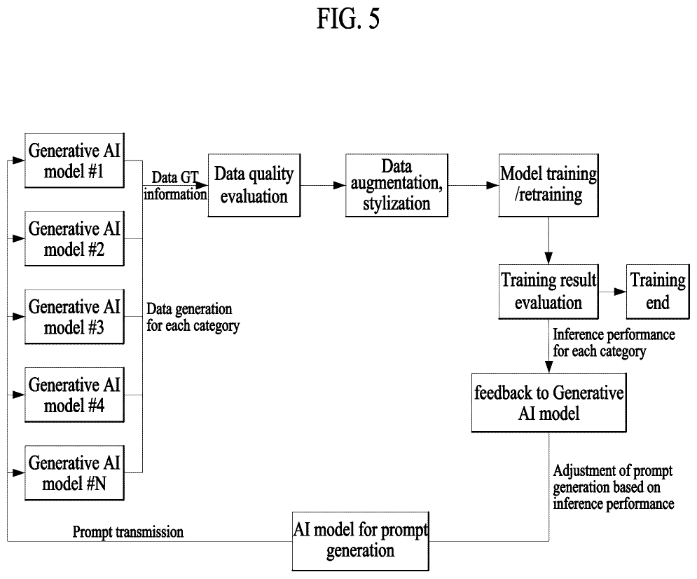

FIG. 5 is a diagram conceptually illustrating a process of training an artificial intelligence model according to an example embodiment. For convenience of description, a process illustrated in FIG. 5 will be described with each module illustrated in FIG. 4 serving as a performing entity.

A data generator 1111 may generate, by using one or more generative artificial intelligence models, a dataset reflecting various scenarios and background conditions. The number of generative artificial intelligence models used by the data generator 1111 may be different according to an example embodiment. When various generative artificial intelligence models are used, by using a generative artificial intelligence model that has a strength in each scenario and environment (background condition), it is possible to increase quality of an initially generated dataset. For example, the data generator 1111 may visualize, by using N generative artificial intelligence models, specific natural situations, such as “a ship on a stormy sea late at night,” or “a ship on a snowy sea,” to generate data by which an artificial intelligence model as a target to be trained may learn under a condition similar to the reality.

Meanwhile, the data generator 1111 may dynamically adjust a generation ratio of data for each of a plurality of categories according to control of a feedback instruction generator 1119 that will be described below. For example, for a category with low inference performance of an artificial intelligence model, such as a condition like “winter” or “typhoon,” the data generator 1111 may generate more data reflecting the condition to enable the artificial intelligence model to enhance learning under the condition. Conversely, by reducing data generation for a category with high inference performance, it is possible to construct an efficient training dataset.

A quality evaluator 1113 may determine quality of the dataset generated by the data generator 1111. This is to prescreen low-quality data through quality evaluation on the generated dataset, since quality of learning data plays an important role in enhancing performance of an artificial intelligence model.

This will be described in more detail with reference to FIG. 6. FIG. 6 is a diagram illustrating a process of evaluating image quality in detail according to an example embodiment. As illustrated, a quality evaluator 1113 may input data and information on a GT of the data into a plurality of pre-trained first artificial intelligence models and check whether the first artificial intelligence models output inference results similar to the GT. A reason for using the plurality of first artificial intelligence models based on various architectures is that inference performance for equal data may vary depending on each architecture, such as YOLO, ImageNet, COCO, Ship, or Transformer-based models, and thus, it is intended to avoid evaluating quality of data based solely on a specific architecture (when quality of data is determined based solely on a specific architecture, the quality evaluation may not ensure reliability).

Thereafter, the quality evaluator 1113 may determine whether each of output inference results corresponds to the GT matching the data and then preserve the data when a ratio of the inference results corresponding to the GT to total inference results is equal to or greater than a preset threshold or greater. As illustrated in FIG. 6, when inference results of a first artificial intelligence model #1, a first artificial intelligence model #3, and a first artificial intelligence model #5 are “success,” and when inference results of a first artificial intelligence model #2 and a first artificial intelligence model #4 are “failure,” among a total of five inference results, three inference results (determined as success) are determined to correspond to a GT, indicating a success rate of 60%. When a threshold ratio is 50%, the data may be determined as high-quality data showing an inference success rate of 60% for the five first artificial intelligence models, and thus the quality evaluator 1113 may preserve the data.

Back to reference to FIG. 5, a data augmentation unit 1115 may perform a task for making a dataset generated by a data generator 1111 more similar to real-world data. For the data preserved through the quality evaluator 1113, the data augmentation unit 1115 may apply various data augmentation techniques, such as stylization (for image data, providing texture or styles similar to an actual picture), image rotation, resizing, and color adjustment, thereby enhancing data diversity and allowing artificial intelligence models to have robustness to various data variations. According to an example embodiment, when applying the stylization technique to data, the data augmentation unit 1115 may analyze an evaluation result for inference performance of a second artificial intelligence model, which is a target to be trained, and automatically apply a stylization option matching in advance for data with a relatively low style of inference performance. Through this, the second artificial intelligence model may efficiently enhance performance for a specific condition.

A model training and evaluation unit 1117 may perform training of the second artificial intelligence model by using the dataset augmented through the data augmentation unit 1115. In this process, a generalization capability and applicability of the second artificial intelligence model are enhanced. After the training ends, the model training and evaluation unit 1117 may evaluate inference performance of the second artificial intelligence model for each of a plurality of categories by using a test dataset. Evaluating inference performance is a task to identify strengths and weaknesses of an artificial intelligence model. The model training and evaluation unit 1117 may identify a category with low inference performance and transmit information on the identified category to a feedback instruction generator 1119. In addition, the model training and evaluation unit 1117 may end the training of the second artificial intelligence model when inference performance for every category becomes a certain threshold value or greater as a result of evaluating the inference performance of the second artificial intelligence model.

The feedback instruction generator 1119 operates based on the inference performance of the second artificial intelligence model for each of the plurality of categories.

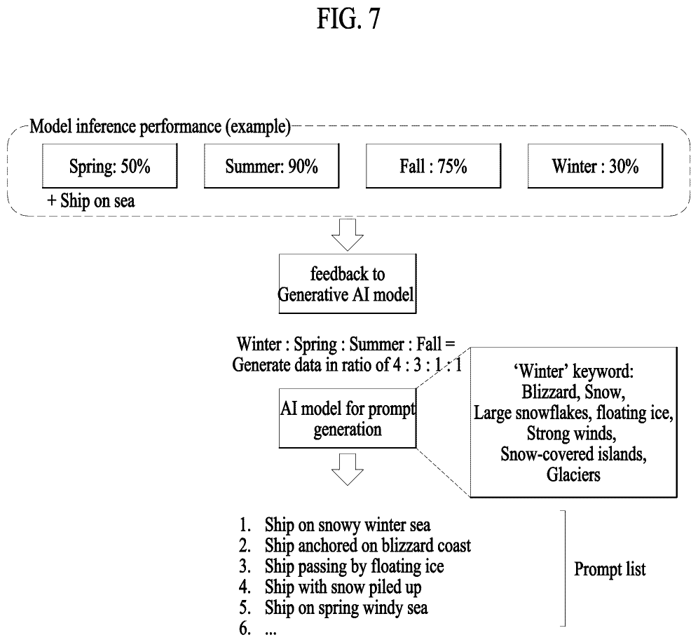

This will be described in more detail with reference to FIG. 7. FIG. 7 is a diagram illustrating a feedback process of a generative artificial intelligence model and an operation process of a prompt generation artificial intelligence model in detail according to an example embodiment. As illustrated, a feedback instruction generator 1119 may provide feedback to a prompt generation artificial intelligence model to generate a large quantity of input prompts to be input into a generative artificial intelligence model for a category (“spring” and “winter” in FIG. 7) in which inference performance of the second artificial intelligence model is relatively low. Conversely, the feedback instruction generator 1119 may provide feedback to reduce the generation of input prompts for a category (“summer” and “fall” in FIG. 7) showing relatively high inference performance.

The prompt generation artificial intelligence model may receive, as input, a plurality of keywords (for example, blizzard, snow, large snowflakes, floating ice, strong winds, snow-covered islands, and glaciers) matching a certain category (as a theme, which is “winter” in FIG. 7), and combine such keywords randomly or use words related to the keywords additionally to generate the input prompts. For example, there is a case in which inference performance is relatively low in a category of “winter” when the second artificial intelligence model is trained to use a sea as a background. The feedback instruction generator 1119 may control the prompt generation artificial intelligence model to generate input prompts including various keywords related to “winter.” In this process, input prompts, such as “a ship on a snowy winter sea,” “a ship anchored on a blizzard coast,” “a ship passing by floating ice,” “a ship with snow piled up,” and “a ship on a spring windy sea,” are generated and transmitted to a data generator 1111.

According to the present disclosure, by automatically generating massive high-quality data required to train an artificial intelligence model, it is possible to easily train an artificial intelligence model even in a field where it is difficult to secure massive high-quality data.

In addition, according to the present disclosure, by adjusting a degree of generation of training data for each of the plurality of categories (fields) in consideration of inference performance of a trained artificial intelligence model, the artificial intelligence model is capable of achieving balanced performance across all of the plurality of categories, thereby enhancing the reliability and generalization capability of the artificial intelligence model and enabling the artificial intelligence model to be utilized more universally thereafter.

The effects of the invention are not limited to those described above, and other effects not explicitly described may be clearly understood by those skilled in the art from the scope of the claims.

The device according to the above-mentioned example embodiments may include a processor, a memory that stores and executes program data, a permanent storage such as a disk drive, a communication port that communicates with an external device, and a user interface device such as a touch panel, a key, and a button. Methods implemented as software modules or algorithms may be stored in a computer-readable recording medium as computer-readable codes or program instructions executable by the processor. Here, the computer-readable recording medium may include a magnetic storage medium (e.g., a read-only memory (ROM), a random access memory (RAM), a floppy disk, a hard disk) and an optical reading medium (e.g., a compact disc read-only memory (CD-ROM), a digital versatile disc (DVD)). The computer-readable recording medium may be distributed across computer systems connected through a network, and computer-readable codes may be stored and executed in a distributed manner. The medium may be readable by a computer, stored in the memory, and executed by the processor.

The present example embodiments may be represented by functional blocks and various processing steps. These functional blocks may be implemented by various numbers of hardware and/or software configurations that execute specific functions. For example, the present example embodiments may adopt integrated circuit configurations such as a memory, a processor, a logic circuit, and a look-up table that may execute various functions by control of one or more microprocessors or other control devices. Similarly to that components may be executed by software programming or software components, the present example embodiments may be implemented by programming or scripting languages such as C, C++, java, and assembler language including various algorithms implemented by combinations of data structures, processes, routines, or of other programming configurations. Functional aspects may be implemented by algorithms executed by one or more processors. In addition, the present example embodiments may adopt the related art for electronic environment setting, signal processing, message processing, and/or data processing. The terms “mechanism”, “component”, “means”, and “configuration” may be widely used and are not limited to mechanical and physical components. These terms may include meaning of a series of routines of software in association with the processor.

It will be apparent to those skilled in the art that various modifications and variations can be made in the example embodiments without departing from the spirit or scope of the invention. Thus, it is intended that the present invention cover the modifications and variations of this invention provided they come within the scope of the appended claims and their equivalents.

What is claimed is:

1. A method for training an artificial intelligence model, the method comprising: generating, by using a generative artificial intelligence model, a dataset that corresponds to input prompts and is categorized by a plurality of categories;
deleting partial data from the dataset based on inference results obtained by inputting data included in the dataset into a plurality of pre-trained first artificial intelligence models;
augmenting, by applying a preset algorithm, the dataset from which the partial data is deleted;
training a second artificial intelligence model based on the augmented dataset;
calculating inference performance of the second artificial intelligence model for each of the plurality of categories based on an inference result obtained by inputting a test dataset into the trained second artificial intelligence model; and
adjusting generation of the input prompts for the plurality of categories based on the inference performance.

2. The method of claim 1, wherein the generating of the dataset includes inputting the input prompts classified for each of the plurality of categories into the generative artificial intelligence model.

3. The method of claim 2, wherein the plurality of categories of the input prompts include information matching a keyword that is input into a prompt generation artificial intelligence model for the generation of the input prompts.

4. The method of claim 1, wherein the dataset includes data that is output by the generative artificial intelligence model for the input prompts and ground truths (GTs) matching the input prompts.

5. The method of claim 4, wherein the deleting of the partial data in the dataset comprises:
inputting data of the dataset into each of the plurality of first artificial intelligence models;
determining whether inference results that are output by the plurality of first artificial intelligence models correspond to the GTs matching the data;
preserving the data when a ratio of inference results corresponding to the GTs to total inference results is equal to or greater than a preset threshold; and
deleting the data when the ratio of inference results corresponding to the GTs to total inference results is less than the preset threshold.

6. The method of claim 1, wherein the augmenting of the dataset from which the partial data is deleted comprises performing at least one task among stylization, image rotation, resizing, and color adjustment for at least a portion of data within the dataset from which the partial data is deleted.

7. The method of claim 1, wherein the calculating of the inference performance comprises:
inputting data of the test dataset into the second artificial intelligence model;
determining whether an inference result that is output by the second artificial intelligence model corresponds to a GT matching the data; and
calculating, as the inference performance, accuracy of the second artificial intelligence model for each of the plurality of categories according to a result of the determining.

8. The method of claim 1, wherein the adjusting of the generation of the input prompts for the plurality of categories comprises controlling a prompt generation artificial intelligence model so that a generation ratio for each of the plurality of categories of the input prompts is determined according to the inference performance for each of the plurality of categories.

9. An apparatus for training an artificial intelligence model, the apparatus comprising:
a transceiver;
a memory that stores instructions; and
a processor,
wherein the processor is configured to be connected to the transceiver and the memory to generate, by using a generative artificial intelligence model, a dataset that corresponds to input prompts and is categorized by a plurality of categories, delete partial data from the dataset based on inference results obtained by inputting data included in the dataset into a plurality of pre-trained first artificial intelligence models, augment, by applying a preset algorithm, the dataset from which the partial data is deleted, train a second artificial intelligence model based on the augmented dataset, calculate inference performance of the second artificial intelligence model for each of the plurality of categories based on an inference result obtained by inputting a test dataset into the trained second artificial intelligence model, and adjust generation of the input prompts for the plurality of categories based on the inference performance.

10. A non-transitory computer readable storage medium comprising a medium configured to store computer readable instructions, wherein, when executed by a processor, the computer readable instructions allow the processor to perform a method for training an artificial intelligence model, the method comprising:
generating, by using a generative artificial intelligence model, a dataset that corresponds to input prompts and is categorized by a plurality of categories;
deleting partial data from the dataset based on inference results obtained by inputting data included in the dataset into a plurality of pre-trained first artificial intelligence models;
augmenting, by applying a preset algorithm, the dataset from which the partial data is deleted;
training a second artificial intelligence model based on the augmented dataset;
calculating inference performance of the second artificial intelligence model for each of the plurality of categories based on an inference result obtained by inputting a test dataset into the trained second artificial intelligence model; and
adjusting generation of the input prompts for the plurality of categories based on the inference performance.
